(19) United States
(12) Patent Application Publication
(10) Pub. No.: US 2024/0127071 A1
(43) Pub. Date: Apr. 18, 2024

(54) META-LEARNED EVOLUTIONARY STRATEGIES OPTIMIZER

(71) Applicant: DeepMind Technologies Limited, London (GB)

(72) Inventors: Robert Tjarko Lange, Berlin (DE); Tom Schaul, London (GB); Yutian Chen, Cambridge (GB); Tom Ben Zion Zahavy, London (GB); Valentin Clement Dalibard, London (GB); Christopher Yenchuan Lu, San Diego, CA (US); Satinder Singh Baveja, Ann Arbor, MI (US); Johan Sebastian Flennerhag, London (GB)

(21) Appl. No.: 18/475,859

(22) Filed: Sep. 27, 2023

Related U.S. Application Data
(60) Provisional application No. 63/410,939, filed on Sep. 28, 2022.

(51) Int. Cl. G06N 3/086

(52) U.S. Cl. CPC G06N 3/086

(57) ABSTRACT

There is provided a computer-implemented method for updating a search distribution of an evolutionary strategies optimizer using an optimizer neural network comprising one or more attention blocks. The method comprises receiving a plurality of candidate solutions, one or more parameters defining the search distribution that the plurality of candidate solutions are sampled from, and fitness score data indicating a fitness of each respective candidate solution of the plurality of candidate solutions. The method further comprises processing, by the one or more attention neural network blocks, the fitness score data using an attention mechanism to generate respective recombination weights corresponding to each respective candidate solution. The method further comprises updating the one or more parameters defining the search distribution based upon the recombination weights applied to the plurality of candidate solutions.

### CROSS-REFERENCE TO RELATED APPLICATION

This application claims priority under 35 U.S.C. 119 to Provisional Application No. 63/410,939, filed Sep. 28, 2022, which is incorporated by reference.

### BACKGROUND

This specification relates to systems and methods for improved black box optimization, in particular using evolutionary strategies type optimizers.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations for optimization using an improved evolutionary strategies optimizer and for obtaining such an optimizer using meta-learning.

According to an aspect, there is provided a computer-implemented method for updating a search distribution of an evolutionary strategies optimizer using an optimizer neural network comprising one or more attention blocks. The method comprises receiving a plurality of candidate solutions, one or more parameters defining the search distribution that the plurality of candidate solutions are sampled from, and fitness score data indicating a fitness of each respective candidate solution of the plurality of candidate solutions. The method further comprises processing, by the one or more attention neural network blocks, the fitness score data using an attention mechanism to generate respective recombination weights corresponding to each respective candidate solution. The method further comprises updating the one or more parameters defining the search distribution based upon the recombination weights applied to the plurality of candidate solutions.

An evolutionary strategies (ES) optimizer is a type of black-box optimization algorithm that is capable of performing optimization tasks without the need to determine gradients and is therefore capable of optimizing both differentiable and non-differentiable functions. A typical ES optimizer employs a search distribution that is defined by one or more parameters, and from which candidate solutions to the optimization task are drawn. The search distribution takes the form of a probability distribution such as a Gaussian distribution parameterized by a mean and standard deviation/covariance. Each of the candidate solutions, also known as population members, are evaluated on the optimization task to determine a fitness score of the candidate solution, i.e. a measure of how well the candidate solution fulfills the optimization task. From the fitness scores, a set of recombination weights may be determined for each candidate solution. The recombination weights define the contribution of each candidate solution to an update to the parameters of the search distribution. For example, candidate solutions with higher fitness scores may have a larger contribution than those with lower fitness scores. The parameters of the search distribution are then updated based upon the candidate solutions weighted by the recombination weights. Updating the search distribution in this way leads to moving the search space towards candidate solutions with higher fitness values, and therefore towards more optimal solutions. The procedure can be repeated for a number of iterations, known as generations, in order to successively move the search distribution and to find an optimal solution for the optimization task.

Typically in an ES optimizer, the recombination weights and the rules for updating the parameters of the search distribution are hand-designed. In the present disclosure, the update rules are parameterized by an optimizer neural network comprising one or more attention blocks; that is, the recombination weights are generated by one or more attention blocks of the optimizer neural network. The update rules may therefore be learned and may be adapted according to the optimization task, current population and generation. In addition, the use of attention blocks provides for population order invariance, that is, the update of the search distribution is invariant to the ordering of the candidate solutions.

The method may further comprise the following optional features.

The method may further comprise generating the plurality of candidate solutions by sampling from the current search distribution and generating the fitness score data indicating a fitness of each respective candidate solution of the plurality of candidate solutions by evaluating the candidate solutions on an optimization task. Examples of optimization tasks are provided below.

Processing, by the one or more attention neural network blocks, the fitness score data using an attention mechanism to generate respective recombination weights corresponding to each respective candidate solution may comprise processing, by a query embedding neural network, the fitness score data to generate a query embedding for each respective candidate solution; processing, by a key embedding neural network, the fitness score data to generate a key embedding for each respective candidate solution; processing, by a value embedding neural network, the fitness score data to generate a value embedding for each respective candidate solution; generating attention weights based upon a dot product attention mechanism between the query embedding and key embedding for each respective candidate solution; and generating the recombination weights corresponding to each respective candidate solution based upon applying the attention weights to the value embedding for each respective candidate solution. In general, an attention mechanism, such as self-attention, provides a pairwise comparison between elements of an input sequence to determine which elements are of particular relevance and to generate an output sequence based upon the determined relevance. For example, a self-attention mechanism may be configured to apply each of a query transformation e.g. defined by a matrix W^{Q}, a key transformation e.g. defined by a matrix W^{K}, and a value transformation e.g. defined by a matrix W^{V}, to the attention layer input for each element denoted by a vector x of the input sequence X (where X is a matrix in which each row is one of the elements x of the sequence; note that the number of rows of X may be limited to a value N+1, so that the output of the attention mechanism for a given input x may only be based on that input x and the N preceding inputs) to derive a respective query matrix (formed of query vectors) Q=XW^{Q}, a respective key matrix (formed of key vectors) K=XW^{K}, and a respective value matrix (formed of value vectors) V=XW^{V}. The attention mechanism may be a dot product attention mechanism applied by applying each query vector to each key vector to determine respective weights for each value vector, then combining the value vectors using the respective weights to determine the attention layer output for each element of the input sequence. The attention layer output may be scaled by a scaling factor e.g. by the square root of the dimensions of the queries and keys, to implement scaled dot product attention or by another scaling factor such as square root of the number of candidate solutions. The attention layer output may be scaled by a scaling factor e.g. by the square root of the dimensions of the queries and keys, to implement scaled dot product attention. Thus, for example, an output of the attention mechanism may be determined as

$$\\ softmax ( \frac{{QK}^{T}}{\sqrt{d}} ) V$$

where d is a dimension of the key vector (the query vector, and in some cases the value vector, have the same dimension). A summation over the value vectors included in V is assumed here, weighted by the respective values

$$\\ softmax ( \frac{{QK}^{T}}{\sqrt{d}} ) .$$

In the case that the attention mechanism is not a self-attention mechanism, i.e. each attention layer input x is applied to another data matrix Y having rows composed of corresponding vector elements y, the key matrix and value matrix are multiplied by Y rather than X, to give the corresponding matrix of key vectors and value vectors. In another implementation the attention mechanism comprises an “additive attention” mechanism that computes the compatibility function using a feed-forward network with a hidden layer. As previously mentioned, output of the attention mechanism may be further processed by one or more fully-connected, feed forward neural network layers.

The key, query and value embedding neural networks comprise learnable parameters. The key, query and value embedding neural networks may each be single linear layer neural networks, i.e. a single weight matrix as indicated above.

The attention mechanism may implement multi-head attention; that is, it may apply multiple different attention mechanisms in parallel to provide a plurality of attention blocks in parallel. The outputs of these may then be combined, e.g. concatenated, with a learned linear transformation applied to reduce to the original dimensionality if necessary. In addition, or alternatively, there may be successive layers of attention blocks to provide for modelling of higher order interactions.

The fitness score data may comprise one or more of the following: a fitness score for a respective candidate solution, a ranking of the respective candidate solution, and an indication of whether the fitness score of the respective candidate solution exceeds a previous best fitness score.

The fitness score may be determined from a fitness function as deemed appropriate by a person skilled in the art on the basis of the optimization task being performed. In some instances, the optimization task is to maximize or minimize a function and the fitness score may simply be the output of the function when evaluated using the candidate solution as input. In other instances, the optimization task may be to obtain a neural network for performing a task. This may include determining the parameters of the neural network and/or architecture. The fitness function may be based upon a neural network loss function. In another instance, the optimization task may be to obtain a control policy for controlling agent interacting with an environment in a reinforcement learning system. The control policy may be parameterized by a neural network. The control policy may receive and process an observation characterizing the state of the environment to generate an output indicating an action for the agent to take. The system may cause the agent to take the action. The fitness function may be based upon the reward obtained by the agent. Example optimization tasks are discussed in more detail below.

The fitness score may be normalized; for example, the normalized fitness score may be a z-score. The ranking of respective candidate solutions may be an ordering of the respective candidate solutions by fitness score (with a lower rank corresponding to a higher value of the fitness score). Thus, each candidate solution may be assigned a rank from 1 to N. However, different ranking values may be used. For example, the ranking may be a centered rank transformation. For example, the ranking values may lie within [−0.5, 0.5] with the highest rank (i.e. the candidate solution with the worst fitness score) given a value of 0.5, the lowest rank given a value of −0.5 and other ranks evenly spread within the range.

The indication of whether the fitness score of the respective candidate solution exceeds a previous best fitness score may be a Boolean value.

The fitness score data may be a matrix that comprises a normalized fitness score, a centered rank transformation value and a Boolean indicator for each candidate solution.

The search distribution may be based upon a Gaussian distribution. In one example, the search distribution is a diagonal Gaussian distribution and the one or more parameters comprise a mean vector and a standard deviation vector. These vectors may each have the same number of components D as the number of components of each candidate solution.

Updating the one or more parameters defining the search distribution based upon the recombination weights applied to the plurality of candidate solutions may comprise: aggregating the values of recombination weights applied to the plurality of candidate solutions and applying a learning rate parameter to the aggregated values to generate an update value; and updating the one or more parameters based upon the update value.

The aggregation may be dependent on the parameter type. For example, the aggregation may be a sum of the candidate solutions weighted by the recombination weights. This may be appropriate where the parameter being updated is a mean parameter of a Gaussian distribution. In another example, the aggregation may comprise a weighted sum of squared differences between the candidate solution and a mean value and taking a square root. More concretely, the aggregation may be \sqrt{Σⱼ₋₁^{N}wⱼ(xⱼ−m)²}. This may be appropriate where the parameter being updated is a standard deviation parameter of a Gaussian distribution.

The update of the one or more parameters may be based upon an exponential moving average. For example, the update may take the form: mₜ₊₁=(1−α)*mₜ+α*y where mₜ₊₁ is the value of the updated parameter, mₜ is the current value of the parameter (e.g. one component of mean vector, having respective components for each dimension of the sample), α is a learning rate parameter (e.g. a scalar value, which may, or may not, be the same for all dimensions of the sample) and y is an aggregated value. Note that there may be different learning rate parameters for mean values and standard deviation values. Furthermore, optionally there may be different learning rate parameter(s) for each corresponding component of the candidate solutions.

The optimizer neural network may further comprise a learning rate update unit configured to process an input based upon the recombination weights and current value(s) of the learning rate parameter(s), to generate updated value(s) for the learning rate parameter(s).

The learning rate update unit may be further configured to process a timestamp embedding to generate the updated value(s) for the learning rate parameter(s). The timestamp embedding may provide an indication of how many generations/iterations the optimizer has been running for.

The updates may be based upon an exponential moving average. For example, the learning rate update unit input may be computed as: p_{c,t+1}=(1−α_{pc})p_{c,t}+α_{pc}(Σⱼwⱼ(xⱼ−mₜ)−p_{c,t}) for a mean parameter of a Gaussian distribution, where xⱼ is candidate solution j, wⱼ is the recombination weight for candidate solution j, mₜ is the current mean parameter value, p_{c,t} is a scalar quantity which is recursively generated by the equation (starting from a first value, e.g. denoted p_{c,0}, which may take a predetermined value or be selected from a distribution), and α_{pc} is a timescale parameter. For a standard deviation parameter, the learning rate update unit input may be computed as: p_{σ,t+1}=(1−α_{pσ})p_{σ,t}+α_{pσ}(Σⱼwⱼ(xⱼ−mₜ)/σₜ−p_{σ,t}) where σₜ is the current standard deviation parameter, p_{σ,t} is a scalar quantity which is recursively generated by the equation (starting from a first value, e.g. denoted p_{σ,0}, which may take a predetermined value or be selected from a distribution), and α_{pσ} is another timescale parameter.

The accumulation of previously generated learning rate update unit inputs may comprise a plurality of accumulations operating at different timescales. For example, where the relationship is based upon an exponential moving average, the α_{pc} timescale parameter may be set to different values which affects how quickly older values are discounted. In one example, three different timescales are used with α_{pc} and α_{pσ} set to 0.1, 0.5 and 0.9.

The method may further comprise generating a solution using the updated search distribution and outputting the generated solution. For example, a further plurality of candidate solutions may be sampled from the updated search distribution, the fitness of the further candidate solutions evaluated and the candidate solution having the best fitness may be output. The process of updating the search distribution may however be carried out for multiple iterations prior to outputting a solution.

The evaluation of the fitness of candidate solutions may be carried out in parallel. For example, each respective candidate solution may be allocated to a respective computing unit of a distributed system for determining the fitness of the candidate solution. The determined fitness data may then be collected and used to determine an update to the search distribution or for selecting a candidate solution to output. The parallel evaluation of candidate solutions improves the efficiency of the optimization procedure and enables support for processing larger number of candidate solutions per iteration to provide better estimates for updating the search distribution or can shorten the amount of time required to complete the optimization procedure. The provision to evaluate candidate solutions in parallel means that method is specifically adapted to implementation on distributed systems. A distributed system may comprise a plurality of computing units in separate devices in one or more locations communicating via a network and/or a distributed system may be a plurality of processing units located on one or more chips, such as a graphics processing unit, a tensor processing unit or other hardware accelerator.

The one or more parameters of the search distribution may be multi-dimensional and each dimension of the one or more parameters may be independently updated. For example, each dimension may be updated in parallel using a distributed system comprising a plurality of computing units.

As discussed above, the evolutionary strategies optimizer may be configured to output a neural network for performing a task and each respective candidate solution represents a candidate neural network for performing the task. Example tasks performed by the candidate neural networks are described in more detail below.

According to another aspect, there is provided a computer-implemented method of obtaining a neural network parameterization defining an optimizer neural network comprising one or more attention blocks, the method comprising sampling from a meta-search distribution to obtain a plurality of candidate optimizer neural network parameterizations. The method further comprises selecting a plurality of optimization tasks and for each respective candidate optimizer neural network parameterization, executing the plurality of optimization tasks using an evolutionary strategies optimizer, wherein the evolutionary strategies optimizer comprises an optimizer neural network for updating a search distribution of the evolutionary strategies optimizer and wherein the candidate optimizer neural network parameterization is used to initialize the optimizer neural network. Executing an optimization task comprises: sampling a plurality of candidate solutions for the optimization task based upon a task search distribution of the evolutionary strategies optimizer; evaluating the plurality of candidate solutions on the optimization task to determine fitness score data indicating a fitness of each respective candidate solution for the optimization task and storing said fitness score data; processing, by the one or more attention neural network blocks of the optimizer neural network, the fitness score data using an attention mechanism to generate respective recombination weights corresponding to each respective candidate solution; and updating one or more parameters defining the task search distribution based upon the recombination weights applied to the plurality of candidate solutions. The method further comprises determining a meta-fitness score for each of the candidate optimizer neural network parameterizations based upon the stored fitness score data obtained during the execution of the plurality of optimization tasks; updating one or more parameters defining the meta-search distribution based upon the meta-fitness scores; and outputting an optimizer neural network parameterization based upon the updated meta-search distribution.

The method may be used to “meta-learn” an optimizer neural network used for updating a search distribution, i.e. a parametrization of an update rule, in an ES optimizer as in the previous method aspect. The method may be used to determine the parameters of the optimizer neural network and/or for determining the architecture of the optimizer neural network.

The method provides a meta-learning method which can use relatively low dimension optimization tasks (e.g. 2 to 10 dimensional optimization problems) for learning and yet can generate robust update rules for an ES optimizer that can generalize to optimization tasks of higher dimensionality and different domains. For example, an ES optimizer with update rules/optimizer neural network learned using low-dimensional optimization problems can be used for obtaining neural networks for computer vision tasks and control policies for agents in a reinforcement learning system.

It will be appreciated that the features of the previous method aspect may be combined with the present method aspect as appropriate.

The plurality of optimization tasks may be selected from a set of optimization functions having one or more of the following properties: a separable function, a function with multi-modal optima and a high conditioning function. The set of optimization functions may comprise one or more of the following functions: Sphere, Rosenbrock, Discus, Rastrigin, Schwefel, BuecheRastrigin, AttractiveSector, Weierstrass, SchaffersF7 and GriewankRosenbrock. Further details regarding these optimization functions and their properties may be found in Hansen et al., “Real-parameter black-box optimization benchmarking 2010: Experimental setup.” PhD thesis, INRIA, 2010, and Finck et al., “Real-parameter black-box optimization benchmarking 2010: Presentation of the noisy functions.” Technical Report 2009/21, Research Center PPE, 2010 which are hereby incorporated by reference in their entirety. Additional information may also be found in the Black Box Optimization Benchmark (BBOB) suite available at http://numbbo.github.io/coco/testsuites/bbob.

The plurality of optimization tasks may be randomly selected from the set of optimization functions. The optimization functions may have a dimensionality parameter and may be set to a value between 2 and 10 to create a low dimensional optimization problem. It will be appreciated that other dimensionality values may be used. An offset may be sampled and added to an optimal solution of the optimization function prior to executing the optimization task. The task search distribution may be a diagonal Gaussian distribution. The initial mean and standard deviation may be sampled from a uniform distribution, e.g. between [−5, 5]. Gaussian noise may be added to fitness estimates for each optimization task candidate solution to provide robustness against unreliable estimates.

Executing an optimization task may comprise repeatedly performing the optimization procedure for a plurality of timesteps. That is, the steps of sampling a plurality of candidate solutions, evaluating the plurality of candidate solutions on the optimization task to determine fitness score data, processing the fitness score data and updating the one or more parameters of the task search distribution may be repeated in order to improve the performance on the optimization task. In one example, the task optimization procedure is repeated for 50 timesteps (iterations). It will however be appreciated that the task optimization procedure may be repeated for any suitable number of iterations. The number of iterations need not be fixed and the task optimization procedure may be repeated until a suitable stopping criterion is reached such as a threshold fitness level. In one example, the number of candidate solutions for each optimization task per iteration is 16, though it will be appreciated that any suitable number of candidate solutions may be generated per iteration per task.

The method may further comprise repeating the meta-optimization procedure for a plurality of iterations (termed “meta-generations”). That is, the steps of sampling from the meta-search distribution to obtain a plurality of candidate optimizer neural network parametrizations; selecting a plurality of optimization tasks, for each respective candidate optimizer neural network parameterization, executing the plurality of optimization tasks, determining a meta-fitness score for each of the candidate optimizer neural network parametrizations and updating the one or more parameters defining the meta-search distribution may be repeated in order to improve the meta-search distribution and to discover an improved optimizer neural network parameterization. In one example, the meta-optimization procedure is repeated for 1500 iterations. It will however be appreciated that the meta-optimization procedure may be repeated for any suitable number of iterations. The number of iterations need not be fixed and the meta-optimization procedure may be repeated until a suitable stopping criterion is reached such as a threshold meta-fitness level. In one example, the number of candidate optimizer neural network parameterizations obtained per iteration is 256, though it will be appreciated that any suitable number of candidate optimizer neural network parameterizations may be obtained. In one example, 128 optimization tasks are executed per candidate optimizer neural network parameterization. It will be appreciated however that any suitable number of optimization tasks may be executed.

The optimizer neural network parameterization that is output may be sampled from the updated meta-search distribution or a plurality of candidate optimizer neural network parameterizations may be sampled and evaluated on a plurality of optimization tasks to determine a meta-fitness score for each candidate optimizer neural network parameterization following the above. The optimizer neural network parameterization that is output may be the parameterization having the best meta-fitness score.

Determining the meta-fitness score may comprise normalizing the fitness score data within a task. In addition, or alternatively, determining the meta-fitness score comprises normalizing the fitness score data across the candidate optimizer neural network parameterizations. For example, a normalization may comprise determining a z-score. The scale of fitness scores for each task may be very different and as such, normalizing the scores within a task and/or across candidates ensures scores of a similar scale and therefore provides more stable meta-optimization. In addition, or alternatively, determining the meta-fitness score may comprise averaging the fitness score data over the plurality of optimization tasks. In addition, or alternatively, determining the meta-fitness score may comprise selecting the best indication of fitness from the fitness score data. In one example, the meta-fitness score is determined by normalizing the fitness scores within tasks and across candidate parameterizations (z-score), taking an average over optimization tasks and maximizing (or minimizing as appropriate) over candidate task solutions and over iterations.

The meta-optimization procedure may use any type of ES optimizer. For example, the CMA-ES technique may be used. Details regarding CMA-ES may be found in Hansen and Ostermeier, “Completely derandomized self-adaptation in evolution strategies”, Evolutionary computation, 9(2):159-195, 2001 which is hereby incorporated by reference in its entirety.

Alternatively, the meta-optimization procedure may be self-evolved from a random initialization of a meta-optimizer neural network. That is, the method may further comprise: initializing a meta-optimizer neural network comprising one or more attention blocks configured to process meta-fitness score data to generate recombination weights for updating one or more parameters defining the meta-search distribution. Updating the one or more parameters defining the meta-search distribution based upon the meta-fitness scores may comprise: processing, by the one or more attention neural network blocks of the meta-optimizer neural network, the meta-fitness scores using an attention mechanism to generate respective recombination weights corresponding to each respective candidate optimizer neural network parameterization; and updating the one or more parameters defining the meta-search distribution based upon the recombination weights applied to the plurality of candidate optimizer neural network parameterizations. Thus, it is possible for the update rules for the meta-optimization procedure to be learned as the meta-optimization procedure progresses.

The method may further comprise updating the meta-optimization neural network and the one or more parameters defining the meta-search distribution based upon the candidate optimizer neural network parameterization having the best meta-fitness score. The updating of the meta-optimization neural network and meta-search distribution parameters with a candidate optimizer neural network parameterization may be conditional on an improvement in the meta-fitness score relative to the meta-fitness score of the current meta-optimization neural network.

The method may be implemented using a distributed system comprising a plurality of processing units and wherein the plurality of optimization tasks are executed in parallel by a respective processing unit of the plurality of processing units. That is, there may be provided a method of obtaining an optimizer neural network comprising one or more attention blocks, the method implemented using a distributed system comprising a plurality of processing units, the method comprising: sampling from a meta-search distribution to obtain a plurality of candidate optimizer neural network parameterizations; selecting a plurality of optimization tasks; for each respective candidate optimizer neural network parameterization, executing the plurality of optimization tasks using an evolutionary strategies optimizer, wherein the evolutionary strategies optimizer comprises an optimizer neural network for updating a search distribution of the evolutionary strategies optimizer and wherein the candidate optimizer neural network parameterization is used to initialize the optimizer neural network; wherein the plurality of optimization tasks are executed in parallel by a respective processing unit of the plurality of processing units, and wherein executing an optimization task by a respective processing unit comprises: sampling a plurality of candidate solutions for the optimization task based upon a task search distribution of the evolutionary strategies optimizer; evaluating the plurality of candidate solutions on the optimization task to determine fitness score data indicating a fitness of each respective candidate solution for the optimization task and storing said fitness score data; processing, by the one or more attention neural network blocks of the optimizer neural network, the fitness score data using an attention mechanism to generate respective recombination weights corresponding to each respective candidate solution; and updating one or more parameters defining the task search distribution based upon the recombination weights applied to the plurality of candidate solutions; determining a meta-fitness score for each of the candidate optimizer neural network parameterizations based upon the stored fitness score data obtained during the execution of the plurality of optimization tasks; updating one or more parameters defining the meta-search distribution based upon the meta-fitness scores; and outputting an optimizer neural network parameterization based upon the updated meta-search distribution.

The optimization tasks are independent and can therefore be executed in parallel in order to improve the efficiency of the meta-optimization process and to support larger numbers of candidate parameterizations. The provision to execute optimization tasks in parallel means that method is specifically adapted to implementation on distributed systems. In addition, as discussed above, further parallelism may be achieved through the independent evaluation of the fitness of each candidate solution on each task. Thus, in addition, or alternatively, the evaluation of the plurality of candidate solutions on the optimization task to determine fitness score data may be carried out in parallel and allocated to respective computing units of the distributed system.

One processing unit of the plurality of processing units may be designated as a control unit that obtains candidate optimizer neural network parameterizations and selects optimization tasks and distributes to the processing units of the distributed system for execution. The determined task fitness score data is stored on a data storage medium accessible to all processing units or local to a processing unit and then transmitted to the control unit to determine a meta-fitness score and to update the meta-search distribution.

According to a further aspect, there is provided a computer-implemented method for updating a search distribution of an evolutionary strategies optimizer, the method comprising: sampling a plurality of candidate solutions for an optimization task from the search distribution, wherein the search distribution is defined by one or more parameters and evaluating the plurality of candidate solutions on the optimization task to determine a fitness score for each respective candidate solution. The method further comprises determining recombination weights for each respective candidate solution for updating the one or more parameters of the search distribution, wherein determining the recombination weights comprises: deriving preliminary weight values for the candidate solutions based on the fitness values, the preliminary weight values having a distribution which follows a sigmoid function of a rank of the fitness values for each candidate solution; and setting the recombination weights based on the preliminary weight values. The method further comprises updating the one or more parameters of the search distribution based upon applying the recombination weights to the candidate solutions.

According to another aspect, there is provided a system comprising one or more computers and one or more storage devices storing instructions that when executed by the one or more computers cause the one or more computers to perform the operations of the above method aspects.

According to another aspect, there is provided one or more computer storage media storing instructions that when executed by one or more computers cause the one or more computers to perform the operations of any of the method or system aspects described above.

In another option, the concepts of the present disclosure may be expressed as an agent (e.g. a mechanical agent, such as a robot) comprising (e.g. in a control unit of the agent) a policy model neural network trained to select actions to be performed by the agent to control the agent to perform the learned task in an environment, wherein the policy model neural network has been trained as explained above.

It will be appreciated that features described in the context of one aspect may be combined with features described in the context of another aspect.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows a first computer-implemented method for updating a search distribution of an evolutionary strategies optimizer.

FIG. 2 shows a second first computer-implemented method for updating a search distribution of an evolutionary strategies optimizer.

FIG. 3 shows a computer-implemented method of obtaining an optimizer neural network.

FIG. 4 shows experimental results obtained using the method of FIG. 1 using an optimizer neural network obtained using an example of the method of FIG. 3, and comparing two benchmark algorithms.

FIG. 5 shows comparing implementations of the current disclosure to two benchmark algorithms for eight optimization tasks.

FIG. 6 shows a further computer-implemented method of obtaining an optimizer neural network.

FIG. 7 shows a further computer-implemented method for updating a search distribution of an evolutionary strategies optimizer.

FIG. 8 shows a further computer-implemented method for obtaining a neural network parameterization defining an evolutionary strategies optimizer.

FIG. 9 shows a further computer-implemented method for updating a search distribution of an evolutionary strategies optimizer.

FIG. 10 shows a reinforcement learning system.

FIG. 11 shows a robot employing a control system.

Like reference numbers and designations in the various drawings indicate like elements.

### DETAILED DESCRIPTION

FIG. 1 shows a method 100 for updating a search distribution of an evolutionary strategies optimizer using an optimizer neural network. The method 100 is an example of a method according to the present disclosure implemented as computer programs on one or more computers in one or more locations in which the systems, components, and techniques described below are implemented.

The method 100 is an example of an Evolution Strategies (ES) algorithm, which is an algorithm which iteratively attempts to find a D-dimensional vector x which minimizes a function ƒ(x). D is an integer which is at least one, and may be much greater than one. Each iteration of the algorithm is based a corresponding distribution over the D-dimensional space containing possibilities (“candidate solutions”) for the vector x. At each iteration (“generation”), labelled by an integer variable t, which takes an initial value of 1.

A first step 101 of the method 100, as in a known ES algorithm, selects N D-dimensional candidate solutions x_{t,j}, j=1, . . . N from the distribution, where N is an integer and j is a variable taking integer values. The value of N may be the same for each iteration, but this is not necessarily the case.

In one example, the distribution is a diagonal distribution (i.e. the product of separate normal distributions for each of the D dimensions). In this case, the ES algorithm may, at any given iteration t, define the corresponding distribution as a Gaussian distribution characterized by a mean vector mₜ∈ [symbol] ^{D} and a standard deviation σₜ∈ [symbol] ^{D}. Thus, for all j=1, . . . N, x_{t,j}∈ [symbol] ^{D} may be a sample from a normal distribution [symbol] (mₜ,\tilde{σ}ₜ), where \tilde{σ}ₜ denotes a D×D matrix which has diagonal elements of σₜ and off-diagonal elements of zero.

In a step 102, as in a known ES algorithm, the fitness of each of the N candidate solutions is assessed, e.g. by assessing a fitness value ƒ_{t,j}(x_{t,j})∈ [symbol] for j=1, . . . N.

The candidate solutions and their corresponding fitness values are used to modify the distribution which is used in the next iteration (“generation”). Based on the corresponding fitness values {ƒ_{t,j}}, a ES algorithm constructs recombination weights {w_{t,j}}, and uses them, with the candidate solutions, to update the mean vector and the standard deviation vector. In a conventional ES algorithm, for example, for a given t, the fitness values {ƒ_{t,j}} can be ranked, thereby giving each candidate solution x_{t,j} a corresponding rank rank(j), where the candidate values with lower ranks have correspondingly higher fitness values. An integer E can be defined, where E is less than N. The recombination weights {w_{t,j}} can be defined as:

$$\\ \begin{matrix}{w}_{t , j} = \{ \begin{matrix}\frac{1}{E} if rank ( j ) \leq E \\ 0 otherwise\end{matrix} , & ( 1 )\end{matrix}$$

Thus E denotes the number of high-fitness candidate which contribute to the recombination weights.

The mean vector and standard deviation vector can then be updated as:

$$\\ \begin{matrix}{m}_{t + 1} = ( 1 - {α}_{m , t} ) {m}_{t} + {α}_{m , t} {\sum }_{j = 1}^{N} {w}_{t , j} {x}_{t , j} , & ( 2 )\end{matrix}$$

$$\\ \begin{matrix}{σ}_{t + 1} = ( 1 - {α}_{σ , t} ) {σ}_{t} + {α}_{σ , t} \sqrt{{\sum }_{j = 1}^{N} {{w}_{t , j} ( {x}_{t , j} - {m}_{t} )}^{2}} & ( 3 )\end{matrix}$$

where α_{m,t} and α_{σ,t} are scalar values which are learning rates. This can be interpreted as a finite-difference gradient update on the expect fitness.

Conventionally, the learning rates α_{m,t}and α_{σ,t} are the same for all generations, and all D components of xⱼ and the weights defined by Eqn. (1) are also fixed to some extent (i.e. E of them are the same, and N−E are zero), which is a restriction to the flexibility of the ES.

By contrast, in the method 100 of the present disclosure, the weights are defined more flexibly, and learnt. A property expected of a learned ES is invariance in the ordering of the population of candidate solutions within a generation. Intuitively, the order of the population of candidate solutions is arbitrary, and therefore should not affect the search distribution update. Motivated by this observation, a natural inductive bias for an appropriate neural network-based parameterization is given by the dot-product self-attention mechanism.

In step 103, the example first determines whether t is less than T. If not, the method 100 terminates by outputting the candidate solution x_{t,j} which was found, in any previous performance of step 103, to have the highest value of ƒ_{t,j}. If so, the employs generate new recombination weights. This process begins by defining a fitness score data matrix Fₜ of population-member specific tokens. In an example used in the experiments presented below, Fₜ∈ [symbol] ^{N×3} may be constructed using:
(1) N respective fitness scores ƒ_{t,j} for the population of N candidate solutions for the present iteration (generation); optionally, these fitness scores may first be modified by z-scoring, a known technique in which the z-score of each fitness score is a measure of the deviation of each the fitness score from a mean fitness score of the group, in terms of the number of standard deviations that deviation represents.
(2) a centered rank transformation, which generates N respective ranking values for the population of N samples, such as values in the range [−0.5,0.5].
(3) a Boolean value indicating whether the fitness score exceeds the previously best score (the best score in the previous iteration).
   In other words, each of the N rows of the matrix Fₜ of fitness score data, corresponding to one of the N candidate solutions, is a tuple of three values: the respective z-scored fitness score, the respective ranking value, and the respective Boolean value.

An attention mechanism is used to process the fitness score data matrix Fₜ, based on a key embedding with a key having Dₖ dimensions, where Dₖ is an integer variable (8 in the experiments presented below).

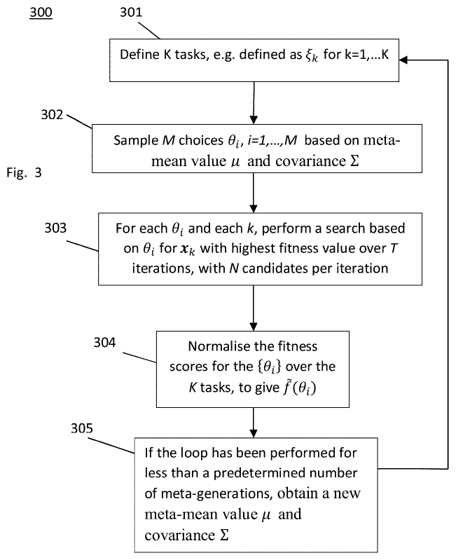

Specifically, two 3×Dₖ matrices W_{K} and W_{Q}, and 1×Dₖ matrix W_{V}, are obtained by training as described below with reference to FIG. 3. These are used, with Fₜ, to define a N×Dₖ “query” matrix Qₜ=FₜW_{Q}, a N×Dₖ “key” matrix Kₜ=FₜW_{K}, and an N×1 “query” matrix Vₜ=FₜW_{V}. For simplicity, in the following the t index will usually be omitted from Q, K and V.

Denoting the N combination values {w_{t,j}} for a given generation t as the vector wₜ∈ [symbol] ^{N}, in the example they are generated from:

$$\\ \begin{matrix}{w}_{t} = softmax ( softmax ( \frac{{QK}^{T}}{\sqrt{{D}_{K}}} ) V ) = softmax ( softmax ( \frac{{F}_{t} {W}_{Q} {W}_{K}^{T} {F}_{t}^{T}}{\sqrt{{D}_{K}}} ) {F}_{t} {W}_{V} ) & ( 4 )\end{matrix}$$

Thus, in the step 103, the recombination weights are obtained based on a set of parameters [W_{Q},W_{K},W_{V}] which may be denoted θ, as well as the various hyperparameters mentioned.

In step 104, these recombination weights are used, in place of the known recombination weights given by Eqn. (1), to update the values mₜ and σₜ using Eqns. (2) and (3), to obtain mₜ and σₜ. The resulting recombination weights are shared across the D search space dimensions, but vary across the generations t. The method 100 then returns to step 101, in which t takes the next higher integer value.

In summary, method 100 is a learning algorithm (evolutionary strategies optimizer) defined by a neural network parameterization, which is a set of numerical parameters θ=[W_{Q},W_{K},W_{V}], as well as by the various hyperparameters.

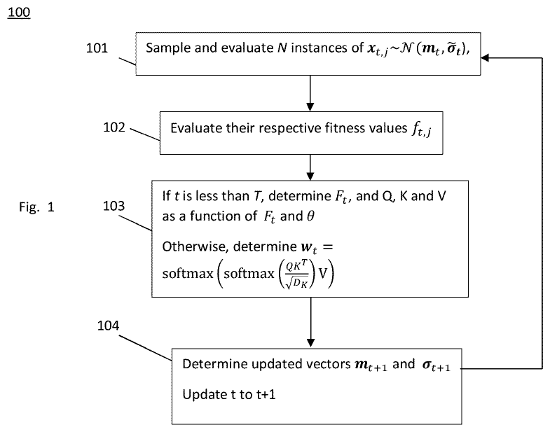

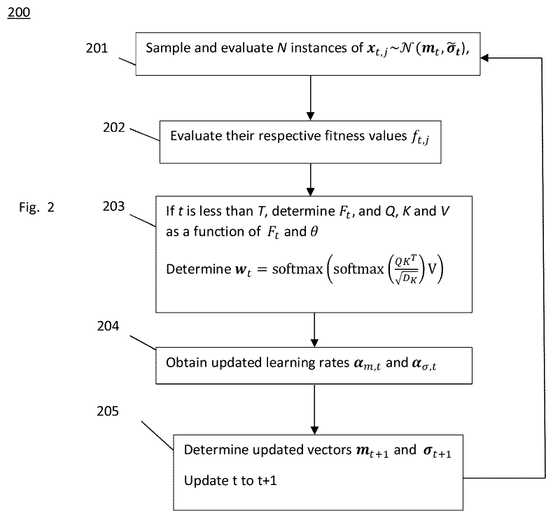

FIG. 2 shows a further example of a method 200 according to the present disclosure. The method 200 is an example of a method implemented as computer programs on one or more computers in one or more locations in which the systems, components, and techniques described below are implemented. Steps 201-203 are the same as corresponding steps 101-103 of method 100 respectively.

In contrast to method 100, the learning rates α_{m,t} and α_{σ,t} used in Eqns. (2) and (3) differ in each generation. Alternatively or additionally, they may be different for different components of x rather than being shared across the D components. That is, they may be D-dimensional vectors, α_{m,t}∈ [symbol] ^{D} and α_{σ,t}∈ [symbol] ^{D}. Eqns. (2) and (3) are thus generalized as:

$$\\ \begin{matrix}{m}_{t + 1} = ( 𝟙 - {α}_{m , t} ) {m}_{t} + {α}_{m , t} {\sum }_{j = 1}^{N} {w}_{t , j} {x}_{t , j} , & ( 5 )\end{matrix}$$

$$\\ \begin{matrix}{σ}_{t + 1} = ( 𝟙 - {α}_{σ , t} ) {σ}_{t} + {α}_{σ , t} \sqrt{{\sum }_{j = 1}^{N} {{w}_{t , j} ( {x}_{t , j} - {m}_{t} )}^{2}} & ( 6 )\end{matrix}$$

where [symbol] is a D-dimensional vector in which each component is 1, and the vector multiplications are to be understood as being performed component-by-component (e.g. the result of the vector multiplication α_{m,t}mₜ is a D-dimensional vector, for which, for each d=1, . . . , D, the d-th component is the product of the d-th components of α_{m,t} and mₜ) and the square root operation in Eqn. (6) is performed component-by-component too.

Step 204 is the derivation of the D-dimensional vectors α_{m,t} and α_{σ,t}. It may be performed using a learning rate update unit comprising a neural network such as a multilayer perceptron (MLP) defined by a set of numerical parameters ϕ. The input at each generation to the MLP may include a function of t itself, such as

$$\\ ρ ( t ) = tanh ( \frac{t}{γ} - 1 ) ,$$

where γ is a hyperparameter. This is referred to as a tanh timestamp embedding.

Additionally, the updating of the learning rates α_{m,t} and α_{σ,t}, may, at each generation, be based on two [symbol] ^{D×3} matrices p_{c,t} and p_{σ,t} to mimic momentum terms at different timescales. These are updated recursively in each generation as follows:

p_{c,t+1}=(1−αₚ_{_{c}})p_{c,t}+αₚ_{_{c}}(Σⱼwⱼ(x_{t,j}−mₜ)−p_{c,t}) (5)

p_{σ,t+1}=(1−αₚ_{_{σ}})p_{σ,t}+αₚ_{_{σ}}(Σⱼwⱼ(x_{t,j}−mₜ)/σₜ−p_{σ,t}) ( (6)

where the scalar hyperparameters αₚ_{_{c}} and αₚ_{_{σ}} represent timescales, and may, for example, be chosen to be equal. They may both, for example, be equal to 0.1, 05 or 0.9. For each t, and for the d-th component of α_{m,t} and α_{σ,t}, the MLP receives seven scalar values p_{c,t+1,d} (i.e. a vector of the three scalar values in row d of the matrix p_{c,t+1}), p_{σ,t+1,d} (i.e. a vector of the three scalar values in row d of the matrix p_{σ,t+1}) and ρ(t), and outputs two scalar values:

α_{m,t,d},α_{σ,t,d}=MLP(p_{c,t+1,d},p_{σ,t+1,d},ρ(t)) (7)

which are the d-th components respectively of the D-dimensional vectors α_{m,t} and α_{σ,t}.

Thus, in the case of method 200, the learning algorithm (evolutionary strategies optimizer) is defined by a neural network parameterization, which is a set of parameters θ=[W_{Q},W_{K},W_{V},ϕ], as well as the various hyperparameters.

The parameters θ used in methods 100, 200 are referred to as LES (learned evolution strategies) parameters.

They may be chosen by any optimization algorithm. Turning to FIG. 3 one possible method 300 is shown for setting the neural network parameterization θ. The method 300 is an example of a method implemented as computer programs on one or more computers in one or more locations in which the systems, components, and techniques described below are implemented. The method 300 proceeds in a number of iterations termed “meta-generations”. Each meta generation is one performance of an “outer loop”, which is the loop shown in FIG. 3.

In each iteration, in step 301 a plurality of tasks, denoted K tasks where K is an integer, labelled by an integer variable k=1, . . . , K, are defined. As an example, the tasks may be sampled from a database of tasks, or from a distribution of tasks. For example, the k-th task may be defined by a set of numerical parameters ξₖ, and in step 301 the values ξₖ for may be sampled from a probability distribution.

In step 302, a number M of candidate sets of LES parameters, θᵢ for i=1, . . . , M, are sampled from a distribution, e.g. a Gaussian distribution, with a “meta-mean” scalar value μₖ and a covariance denoted Σₖ. This process is termed “meta-sampling”.

In step 303 for each task k and each choice of θᵢ, a respective search (“inner loop search”) is performed for parameters xₖ which maximize a corresponding fitness function ƒₖ(x). This search may be performed using method 100 of FIG. 1 or method 200 of FIG. 2. As explained above, this implies, for each choice of the LES parameters θᵢ, using an evolutionary strategies optimizer defined by the neural network parameterization θᵢ. The process comprises (step 102 of method 100, and step 202 of method 200) evaluating a fitness function ƒ(x_{j,t}|ξₖ) for each of N candidate solutions, i=1, . . . , N, at each of T timesteps, t=1, . . . , T.

For each task, a mean vector m₀ and standard deviation vector σ₀ are initiated. If the number of components of x is the same for each optimization task (i.e. the number of components of each candidate solution x_{j,t} is equal to the same value D), than m₀∈ [symbol] ^{D} and σ₀∈ [symbol] ^{D}. More generally, the K tasks may require ƒ(x|ξₖ) to be maximized to a vector x which has a number of components which is different for different values of k. This number may be denoted by \tilde{D}ₖ. In this case, for the k-th task, the mean vector m₀∈ [symbol] ^{\tilde{D}}^{ₖ} and the initial standard deviation vector is σ₀∈ [symbol] ^{\tilde{D}}^{ₖ}. In either case, all the components of the initial mean vector and initial standard deviation vector may initially be zero, or may be selected randomly, e.g. from a uniform distribution over a range.

Step 303 may optionally be carried out by multiple computing units communicating via a network (e.g. graphics processing unit, tensor processing unit or other hardware accelerator) of a distributed system, e.g. such that each computing unit determines the fitness of candidate solutions generated for a respective subset of the M candidate sets of LES parameters (where the subsets for different computing units do not overlap; e.g. there may be one candidate set of LES parameters per computing unit). One computing unit may be designated as a control unit that selects optimization tasks (by performing step 301), obtains candidate optimizer neural network parameterizations (by performing step 302), and distributes candidate optimizer neural network parameterizations to the other computing units of the distributed system for execution of step 303. The determined task fitness score data is stored on a data storage medium accessible to all computing units or local to a computing unit and then transmitted to the control unit to perform steps 304 and 305 described below.

In step 304, the fitness scores \tilde{ƒ}(θᵢ) for the {θᵢ} are obtained from fitness scores generated in step 304. This is termed a “meta-normalization” operation. This can be done by z-scoring the fitness scores for each task across the meta-population members (i.e. the different realisation of θᵢ), and then averaging (e.g. using the mean) the results over the inner-loop tasks, and maximising over the N inner-loop population members and over the T generations.

Thus, step 304 can be performed from the following values collected at step 303:

$$\\ \begin{matrix}{[ {[ {[ {\{ f ( {x}_{j , t} \vert {ξ}_{k} ) \}}_{j = 1}^{N} ]}_{t = 1}^{T} ]}_{k = 1}^{K} \vert {θ}_{i} ]}_{i = 1}^{M} ∈ {ℝ}^{N \times T \times K \times M} . & ( 8 )\end{matrix}$$

From these, in step 304 a fitness score ƒ(θᵢ|ξₖ) for each θᵢ on the k-th task can be generated as:

$$\\ \begin{matrix}f ( {θ}_{i} \vert {ξ}_{k} ) = {min}_{t} {{min}_{j} [ {[ {[ {\{ f ( {x}_{j , t} \vert {ξ}_{k} ) \}}_{j = 1}^{N} ]}_{t = 1}^{T} ]}_{k = 1}^{K} \vert {θ}_{i} ]}_{i = 1}^{M} & ( 9 )\end{matrix}$$

Then the normalized fitness score for θᵢ is given by

\tilde{ƒ}(θ_{□})=median[z−score(ƒ(θᵢ|ξₖ)]ₖ₌₁^{K} (10)

This is found for all i=1, . . . , M.

In step 305, the method 300 determines whether all the meta-generations have now been conducted. If so, the method terminates and the parameters θᵢ which were determined to have the highest normalized fitness score \tilde{ƒ}(θᵢ) are output as an optimizer neural network parameterization which is the final result of the method. Otherwise, step 305 obtains a new meta-mean value μₖ and covariance Σₖ, and returns to step 301 to begin the next meta-generation. This is termed a “meta-update”. It may be performed using a conventional ES algorithm, denoted MetaES.

A pseudo-code explanation of the algorithm, in the case that the search done at step 303 is the method 100, is as follows:

Algorithm 1

```
Inputs: the number of meta-population members M, meta-task size K, inner loop population size
N, inner loop generations T, and algorithm MetaES used in step 305 (e.g. CMA-ES).
Set initial meta-search mean μ₀ and covariance Σ₀
For a predetermined plural number of meta-generations:
  Sample K tasks with parameters ξₖ, ∀k = 1, ... , K
  Sample LES candidates θ_{□}~ [symbol]  (μ, Σ), ∀i, ... , M
    for k=1, ..., K do
      for i=1, ...,M do
        Initialize inner loop search mean and standard deviation m_{1,k,i} ∈ [symbol]   \tilde{^{D}}^{ₖ}, σ_{1,k,i} ∈ [symbol]   \tilde{^{D}}^{ₖ}
        for t=1, ... T do
          Sample inner loop candidates x_{j,t}~ [symbol]  (m_{t,k,i},\tilde{σ}_{t,k,i}), ∀ⱼ = 1, ... , N
          Evaluate all inner loop candidates f (x_{j,t}|ξₖ), ∀j = 1, ... , N
          Obtain m_{t+1,k,i} and σ_{t+1,k,i} from Eqns. (2) and (3)
        end for
      end for
    endfor
    $Collect all inner loop fitness {scores [ {[ {[ {\{ f ( {x}_{j , t} \vert {ξ}_{k} ) \}}_{j = 1}^{N} ]}_{t = 1}^{T} ]}_{k = 1}^{K} \vert {θ}_{i} ]}_{i = 1}^{M} ∈ {ℝ}^{N \times T \times K \times M}$
Compute the population normalized and task aggregated meta-fitness scores {\tilde{f}(θᵢ)}ᵢ₌₁^{M}
Update meta-mean μ and meta-standard deviation μ, Σ ← MetaES({θᵢ\tilde{f}(θᵢ)|μ, Σ}_{i=1′}^{M}
```

Here the value \tilde{D}ₖ (not to be confused with the number of components Dₖ per row of the matrices Q, K and V) means the number of components of the candidate solutions xₖ for the k-th task, which may vary with the task.

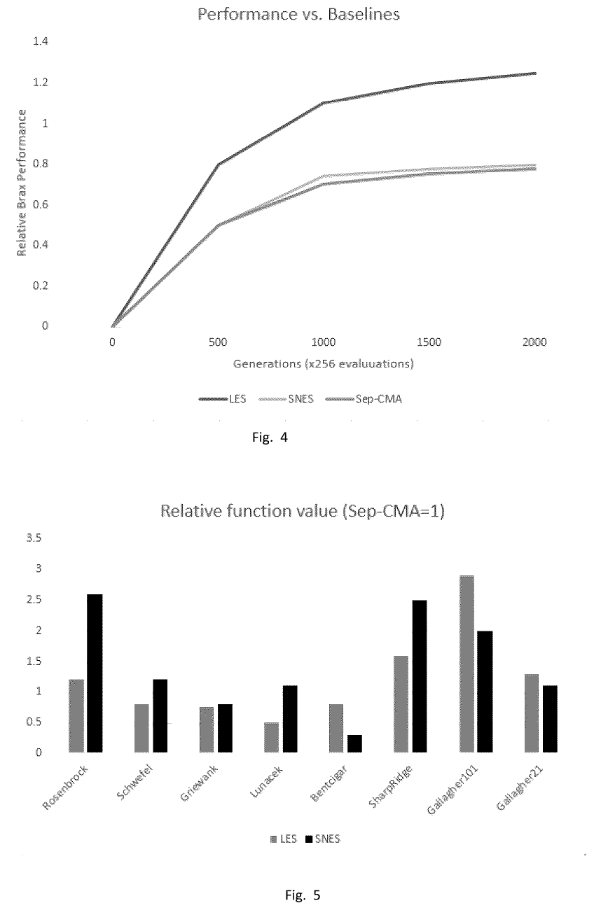

Turning to FIGS. 4 and 5, experimental results are presented comparing the performance of a method 100, performed using an evolutionary strategies optimizer defined by a neural network parameterization obtained using the “LES” method 300, with two benchmark optimization algorithms: sep-CMA-ES (R. Ros and N. Hansen, “A simple modification in cma-es achieving linear time and space complexity”, in International conference on parallel problem solving from nature, pp. 296-305. Springer, 2008) using an elite ratio of 0.5 (“sep-CMA”); and SNES (D. Wierstra, et al, “Natural evolution strategies”. The Journal of Machine Learning Research, 15(1):949-980, 2014). In the method 300, step 305 was performed using the default rank-based fitness transformation, “SNES”, as the MetaES.

In FIG. 4 the averaged normalised performance is shown across 8 continuous control Brax environments (See C. D. Freeman, et al, “Brax—a differentiable physics engine for large scale rigid body simulation. arXiv preprint, arXiv:2106.13281, 2021). It is seen that the performance from LES (the darkest line) outstripped the two baselines. It scaled well with an increased population size (normalized by min-max performance across all strategies). The results are averaged over 10 independent runs, and each task-specific learning curve was normalised based on the largest and smallest fitness across a number of ES algorithms (including LES, SNES and some other ES algorithms which were evaluated, but for which the results are not shown). The normalized learning curves were averaged across all tasks.

In FIG. 5 a comparison is made for eight functions from the BBOB benchmark tasks (N. Hansen, et al. “Real-parameter black-box optimization benchmarking 2010: Experimental setup”. PhD thesis, INRIA, 2010). The vertical axis shows the function value achieved by LES and SNES relative to Sep-CMA (i.e. for each task, a relative function value of 1 means the performance which Sep-CMA achieved for that task). A lower value is better. Thus, it will be seen that LES performed better than Sep-CMA on 4 of the 8 tasks (i.e. the function value for LES was less than one), and better than SNES on 5 of the tasks.

The implementation of LES used D=10, N=16, and T=100. Despite LES only being meta-trained on a population size of N=16 and low dimensional search spaces (D≤10), it proved capable of generalising to different functions, problem settings and resources. In particular, LES generalises well to larger dimensions and larger evaluation budgets on both meta-training and meta-testing function classes. While the complexity increases with D and performance drops for a fixed population size, LES is capable of making use of the additional evaluations provided by an increased population.

As noted, the LES experiments were conducted using CMA-ES as the “meta-ES” of step 305 of method 300, with the following hyperparameters: 1500 meta-generations, a meta-population M of 256, a number of meta-tasks K of 128, the CMA-ES parameter σ₀ set to 0.1, the inner population N of 16, the number of inner generations T of 50, the initial values of the components of m₀ chosen to be in the range [−5,5], the initial values of the components of σ₀ are sampled from the range [0, 10], the attention keys Dₖ=8, and with the MLP having 4 layers and a hidden dimension of 8. The time (“timestamp”) t was encoded with ρ(t)=tanh(t/γ−1) with γ taking values in the range [0,2000]; specifically, [1, 3, 10, 30, 50, 100, 250, 500, 750, 1000, 1250, 1500, 2000].

In some of the experiments it was found that plotting the recombination weights as a function of their centred rank based on their fitness scores give a sigmoid distribution. In other words, the distribution of the weights w_{i,j} generated using Eqn. (4) was, to a high degree, equivalent to using the following soft max parameterization:

w_{i,j}=soft max(20×[1−sigmoid(β×(rank(j)/N)−0.5))]),∀j,1, . . . ,N (11)

In other words, if we denote a preliminary weight value by:

\tilde{w}_{i,j}=sigmoid(β×(rank(j)/N)−0.5)), (12)

(i.e. the preliminary weight values have a distribution which follows a sigmoid function of the rank values, for some choice of a temperature parameter β), the recombination weight values may be set based on the preliminary weight values as:

w_{i,j}=soft max(20×[1−\tilde{w}_{i,j}]) (13)

This allows an approximation of the method 300 to be produced in which Q, K and V are not calculated or used explicitly, and indeed no meta-learning process is necessary (i.e. there is an inner loop but no outer loop), but which is able to optimize a function ƒ(x) to a similar accuracy to method 300 for some classes of function ƒ(x).

Specifically, this form of the method is termed “DES” (Discovered Evolution Strategy), which can be represented by the following pseudocode:

Algorithm 2

```
Input Variables: population member N, search dimensions D, number of generations T, initial
scale σ₀ ∈ [symbol] ^{D}, mean and standard learning rates aₘ and a_{σ}, e.g. aₘ=1 and a_{σ}=0.1,
temperature parameter β, e.g. β = 12.5
  for t=1, ... T do
    Sample candidates x_{j,t}~ [symbol] (mₜ [symbol] ), ∀j = 1, ... , N
    Evaluate the value of f (x_{j,t}), ∀j = 1, ... , N
    Evaluat [symbol] _{t,j=}sigmoid(β × (rank(j)/N) − 0.5))
    Computer recombination weights w_{t,j} = softmax(20 × [1 − \tilde{w}_{i,j}]).
    Obtain mₜ₊₁ and σₜ₊₁ from Eqns. (2) and (3)
  end for
```

This is computationally cheaper than the method 300, and for some classes of optimisation task, gives a solution of substantially similar accuracy. That is, the best candidate sample found after T generations is on average as good as the best candidate found after T generations by the methods 100, 200 when they are carried out using a set of parameters θ which has been found by a meta-optimisation shown in FIG. 3.

The DES method may further include tuning the temperature parameter β, such as by trying out multiple values for the temperature parameter and choosing the one which gives fastest convergence to candidate solutions with high fitness values.

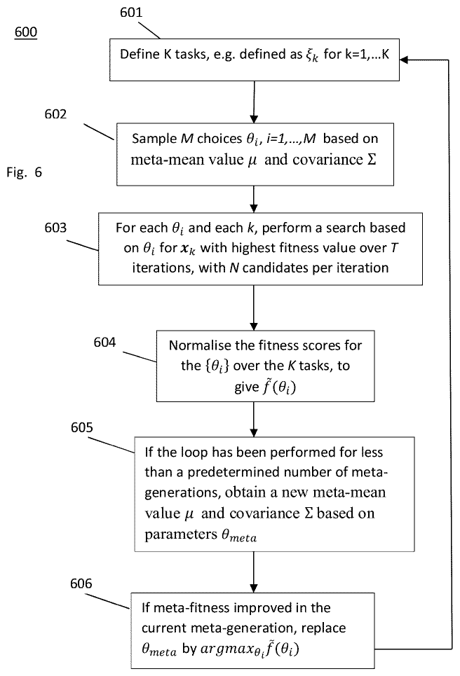

Turning to FIG. 6, a further example of the present methods is shown. Whereas in method 300 of FIG. 3, the meta-updates in step 305 are performed by the algorithm termed “MetaES” in algorithm 1 (which in the experiments presented above was implemented as CMA-ES), in FIG. 6 the meta updates are themselves performed by an LES method.

Specifically, steps 601-604 are performed in a way equivalent to corresponding steps 301-304 of method 300.

In step 605, the method 600 determines whether all the meta-generations have now been conducted. If so, the method terminates and the parameters θᵢ which were determined to have the highest normalized fitness score \tilde{ƒ}(θᵢ) are output as an optimizer neural network parameterization which is the final result of the method. Otherwise, the fitness scores {\tilde{ƒ}(θᵢ)} derived in step 604 for the parameter choices θᵢ, i=1, . . . , M sampled in step 602 are used to generate corresponding fitness matrices Fᵢ of population-member specific tokens. This is done using the process explained above in relation to step 102 of method 100 in FIG. 1 for the population of candidate solutions, but instead this time using the population of parameter choices {θᵢ}. Then, recombination weights {wᵢ} are derived from the fitness matrices {Fᵢ} by the process explained above in relation to step 103 of method 100, using a set of query, key and value matrices [ [symbol] ] which may be denoted θₘₑₜₐ. This is done by an equation which the same as Eqn. (4) but with i replacing t and [ [symbol] ] replacing [W_{Q},W_{K},W_{V}]. Based on the recombination weights {wᵢ}, a new meta-mean value μ and covariance Σ are obtained by analogues of Eqns. (2) and (3). In the first meta-generation shown in FIG. 6 (i.e. the first time the set of steps 601-606 is performed), θₘₑₜₐ may be chosen at random.

In step 606, if the best meta-fitness found the last time step 604 was performed (i.e. during the current meta-generation), using a set of parameters θᵢ, is better than the best meta-fitness found in the previous meta-generation, then θₘₑₜₐ is updated to be the θᵢ which gave that better fitness. In other words, θₘₑₜₐ is updated to arg max_{θi}\tilde{ƒ}(θᵢ), over the {θᵢ} generated at step 602 of the meta-generation. θₘₑₜₐ may also be used to update the meta-mean value μ and covariance Σ. The method then returns to step 601 for the next meta-generation to begin.

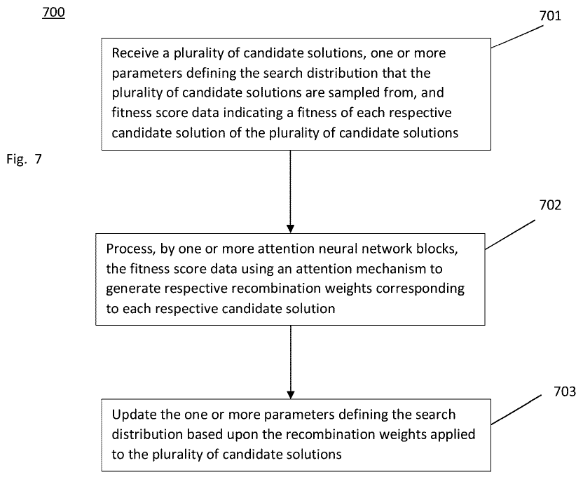

FIGS. 7-9 show exemplary methods 700, 800 and 900. Methods 700, 800 and 900 are examples of methods according to the present disclosure implemented as computer programs on one or more computers in one or more locations. Methods 100-300, the DES algorithm and the method 600 provide specific cases of corresponding ones of these exemplary methods.

Referring first to FIG. 7, in step 701 a plurality of candidate solutions are received. These are sampled from search distributions defined by one or more parameters, and fitness score data is also received indicating a fitness of each respective candidate solution of the plurality of candidate solutions. Step 701 may, for example, be implemented as shown in steps 101, 102 of method 100, and steps 201, 202 of method 200.

In step 702, the fitness score data is processed by one or more attention neural network blocks, using an attention mechanism to generate respective recombination weights corresponding to each respective candidate solution. Step 702 may, for example, be implemented as shown in steps 103 of method 100, and step 203 of method 200.

In step 703, the one or more parameters defining the search distribution are updated based upon the recombination weights applied to the plurality of candidate solutions. Step 703 may, for example, be implemented as shown in steps 104 of method 100, and step 205 of method 200.

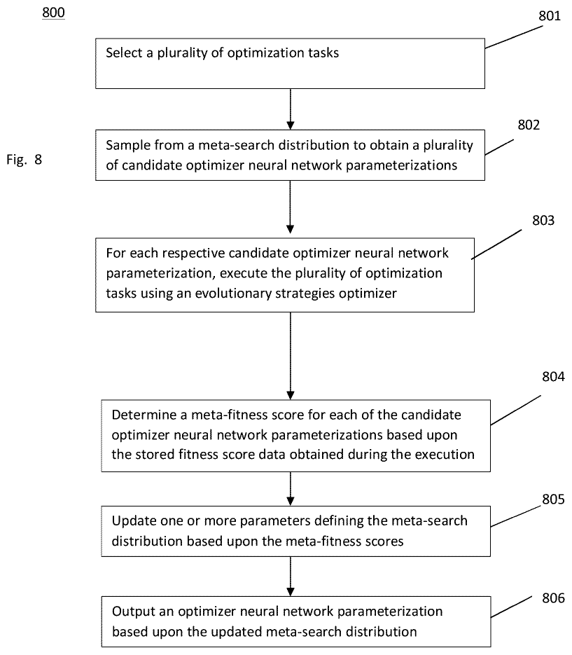

Turning to FIG. 8, a method 800 is shown for obtaining an optimizer neural network comprising one or more attention blocks. The method may, for example, be implemented using a distributed system comprising a plurality of processing units.

In step 801, a plurality of optimization tasks are selected. Step 801 may, for example, be implemented as shown in step 301 of method 300, and step 601 of method 600.

In step 802, a plurality of candidate optimizer neural network parameterizations are sampled from a meta-search distribution. Step 802 may, for example, be implemented as shown in step 302 of method 300, and step 602 of method 600.

In step 803, the plurality of optimization tasks are executed for each respective candidate optimizer neural network parameterization, using an evolutionary strategies optimizer defined by the corresponding optimizer neural network parameterization. The tasks may, for example, be executed in parallel by respective ones of the plurality of processing units. Step 803 may, for example, be implemented as shown in step 303 of method 300, and step 603 of method 600.

In step 804, a meta-fitness score for each of the candidate optimizer neural network parameterizations is determined based upon stored fitness score data obtained during the executions in step 803. Step 804 may, for example, be implemented as shown in step 304 of method 300, and step 604 of method 600.

In step 805, one or more parameters defining the meta-search distribution are updated based upon the meta-fitness scores. Step 805 may, for example, be implemented as shown in step 305 of method 300, and step 605 of method 600.

In step 806, an optimizer neural network parameterization based upon the updated meta-search distribution is output. This corresponds to the termination possibility of steps 305 of method 300, and step 605 of method 600.

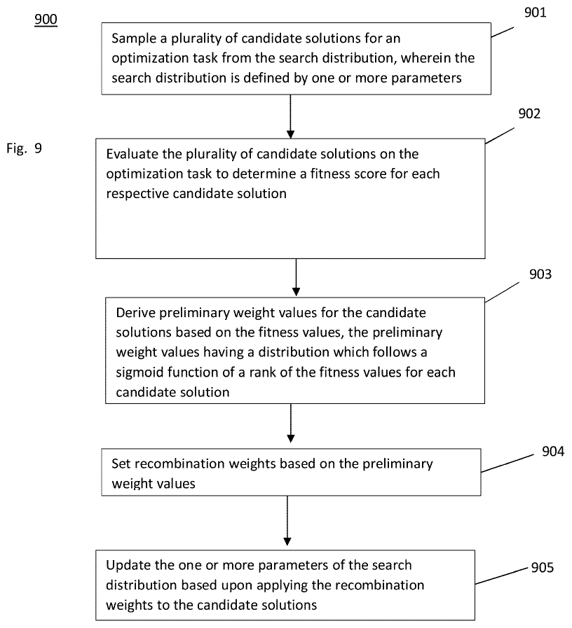

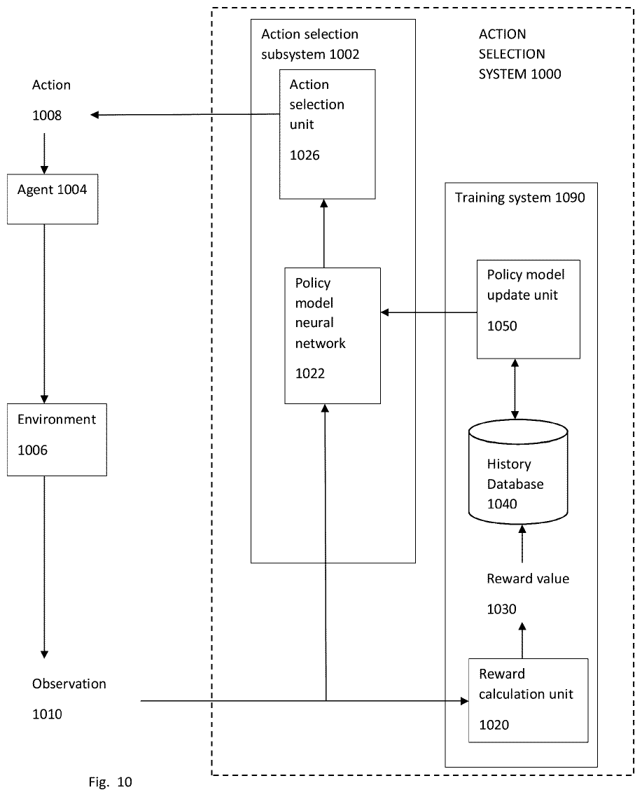

Turning to FIG. 9, in step 901 a plurality of candidate solutions for an optimization task from the search distribution are sampled from a search distribution defined by one or more parameters. Step 901 may, for example, be implemented as shown in steps 101 of method 100, and steps 201 of method 200. Alternatively, it may be implemented in the step of sampling candidate solutions x_{j,t} in DES method.

In step 902, the plurality of candidate solutions for the optimization task are evaluated to determine a fitness score for each respective candidate solution. Step 902 may, for example, be implemented as shown in step 102 of method 100, and step 202 of method 200. Alternatively, it may be implemented in DES method by the step of evaluating the value of f(x_{j,t}) for each of the candidate solutions.

In step 903, preliminary weight values for the candidate solutions are derived based on the fitness values. The preliminary weight values have a distribution which follows a sigmoid function of a rank of the fitness values for each candidate solution. Here the rank is higher for candidate solutions with higher fitness value.

In the DES method, step 903 is performed by ranking the candidate solutions based on the fitness values, to determine a rank value for each candidate solution. Then, the preliminary weight values for the candidate solutions are derived based on the rank values using Eqn. 12, the preliminary weight values having a distribution which follows a sigmoid function of the rank values.

In the methods 100, 200, as noted above, step 903 is generally performed was part of the evaluation of wₜ in steps 103 and 203, since it has been found experimentally that soft max

$$\\ ( \frac{{F}_{t} {W}_{Q} {W}_{K}^{T} {F}_{t}^{T}}{\sqrt{{D}_{K}}} )$$

FₜW_{V}, which is derived as part of the evaluation of wₜ, obeys Eqn. 12.

In step 904, recombination weights are set based on the preliminary weight values. In the methods 100, 200, this is part of steps 103 and 203. In the DES method, it is performed by evaluating soft max(20×[1−\tilde{w}_{t,j}]), i.e. Eqn. 13.

In step 905, the one or more parameters of the search distribution are updated based upon applying the recombination weights to the candidate solutions. Step 905 may, for example, be implemented in steps 104 of method 100, and steps 205 of method 200. In the DES method, it is implemented by the step of obtaining mₜ₊₁ and σₜ₊₁.

As discussed above, an optimization task may be to obtain a neural network for performing a task. Examples of particular neural network tasks that the above may be applied to will now be described.

The neural network can be configured to receive any kind of digital data input and to generate any kind of score, classification, or regression output based on the input.

For example, if the inputs to the neural network are images or features that have been extracted from images, the output generated by the neural network for a given image may be scores for each of a set of object categories, with each score representing an estimated likelihood that the image contains an image of an object belonging to the category. In another example, the task may be object detection, that is, to determine whether an aspect of the image data, such as a pixel or region, is part of an object. Another image-based task may be pose estimation of an object.

The neural network tasks may include any sort of image processing or vision task such as an image classification or scene recognition task, an image segmentation task e.g. a semantic segmentation task, an object localization or detection task, a depth estimation task. When performing such a task the input may comprise or be derived from pixels of the image. For an image classification or scene recognition task the output may comprise a classification output providing a score for each of a plurality of image or scene categories e.g. representing an estimated likelihood that the input data item or an object or element of the input data item, or an action within a video data item, belongs to a category. For an imageaw segmentation task the output may comprise, for each pixel, an assigned segmentation category or a probability that the pixel belongs to a segmentation category, e.g. to an object or action represented in the image or video. For an object localization or detection task the output may comprise data defining coordinates of a bounding box or region for one or more objects represented in the image. For a depth estimation task the output may comprise, for each pixel, an estimated depth value such that the output pixels define a (3D) depth map for the image. Such tasks may also contribute to higher level tasks e.g. object tracking across video frames; or gesture recognition i.e. recognition of gestures that are performed by entities depicted in a video.

Another example image processing task may include an image keypoint detection task in which the output comprises the coordinates of one or more image keypoints such as landmarks of an object represented in the image, e.g. a human pose estimation task in which the keypoints define the positions of body joints. A further example is an image similarity determination task, in which the output may comprise a value representing a similarity between two images, e.g. as part of an image search task.

The input to the neural network may be a video data item. Possible video tasks include action recognition, that is, to determine what action is being performed in a video or a segment (aspect) of a video, and action detection to determine whether an action is being performed in a segment of video.

As another example, if the inputs to the neural network are Internet resources (e.g., web pages), documents, or portions of documents or features extracted from Internet resources, documents, or portions of documents, the output generated by the neural network for a given Internet resource, document, or portion of a document may be a score for each of a set of topics, with each score representing an estimated likelihood that the Internet resource, document, or document portion is about the topic.

As another example, if the inputs to the neural network are features of an impression context for a particular advertisement, the output generated by the neural network may be a score that represents an estimated likelihood that the particular advertisement will be clicked on.

As another example, if the inputs to the neural network are features of a personalized recommendation for a user, e.g., features characterizing the context for the recommendation, e.g., features characterizing previous actions taken by the user, the output generated by the neural network may be a score for each of a set of content items, with each score representing an estimated likelihood that the user will respond favorably to being recommended the content item.

As another example, if the input to the neural network is a sequence of text in one language, the output generated by the neural network may be a score for each of a set of pieces of text in another language, with each score representing an estimated likelihood that the piece of text in the other language is a proper translation of the input text into the other language.

As another example, if the input to the neural network is a sequence representing a spoken utterance, the output generated by the neural network may be a score for each of a set of pieces of text, each score representing an estimated likelihood that the piece of text is the correct transcript for the utterance. As another example, if the input to the neural network is a sequence representing a spoken utterance, the output generated by the neural network can indicate whether a particular word or phrase (“hotword”) was spoken in the utterance. As another example, if the input to the neural network is a sequence representing a spoken utterance, the output generated by the neural network can identify the natural language in which the utterance was spoken. Thus in general the model input may comprise audio data for performing an audio processing task and the model output may provide a result of the audio processing task e.g. to identify a word or phrase or to convert the audio to text.

As another example, the task can be a health prediction task, where the input is a sequence derived from electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

As discussed above, the optimization task may be to generate a control policy for controlling agent interacting with an environment in a reinforcement learning system. FIG. 1 shows an example of a reinforcement learning system including an action selection system 1000. The action selection system 1000 is an example of a system implemented as computer programs on one or more computers in one or more locations in which the systems, components, and techniques described below are implemented.

The action selection system 1000 controls an agent 1004 interacting with an environment 1006 to accomplish a task by selecting actions 1008 to be performed by the agent 1004 at each of multiple time steps during an episode in which the task is performed.

As a general example, the task can include one or more of, e.g., navigating to a specified location in the environment, identifying a specific object in the environment, manipulating the specific object in a specified way, controlling items of equipment to satisfy criteria, distributing resources across devices, and so on.

More generally, the task is specified by received rewards, e.g., such that an episodic return is maximized when the task is successfully completed. Rewards and returns will be described in more detail below. Examples of agents, tasks, and environments are also provided below.

An “episode” of a task is a sequence of interactions during which the agent attempts to perform a single instance of the task starting from some starting state of the environment. In other words, each task episode begins with the environment being in an initial state, e.g., a fixed initial state or a randomly selected initial state, and ends when the agent has successfully completed the task or when some termination criterion is satisfied, e.g., the environment enters a state that has been designated as a terminal state or the agent performs a threshold number of actions without successfully completing the task.

At each time step during any given task episode, the system 1000 receives an observation 1010 characterizing the current state of the environment 1006 at the time step and, in response, selects an action 1008 to be performed by the agent 1004 at the time step. An action to be performed by the agent will also be referred to in this specification as a “control input” generated by the action selection system 1000. After the agent performs the action 1008, the environment 1006 transitions into a new state at the next time step.

To control the agent, at each time step in the episode, an action selection subsystem 1002 of the system 1000 may use a policy model neural network 1022 and optionally an action selection unit 1026 (e.g. a low-level controller neural network) to select the action 1008 that will be performed by the agent 1004 at the time step based on the output of the policy model neural network (the “policy output”). Thus, the action selection subsystem 1002 uses the policy model neural network 1022 to process the observation 1010 to generate the policy output, and then the action selection unit 1026 uses the policy output to select the action 1008 to be performed by the agent 1004 at the time step.

The function performed by the policy model neural network 1022 is defined by a set of parameters ψ which may comprise weights and/or bias values of neural units (nodes), each of which is located in one of one or more layers of the policy model neural network, and which generates an output as a function (e.g. a non-linear function) of a weighted sum of the inputs to the neural unit plus a bias value. The input to the policy model neural network 1022 comprises the observation 1010, and may further comprise an action a which the agent may take in response to the observation 1010.

In one example, the policy output may uniquely identify an action (e.g. it may be a “one-hot” vector which has respective components for each possible action, and for which only one of the components is non-zero, indicating that the corresponding action should be taken. In this case, the action selection unit 1026 may be omitted (i.e. the policy output may be transmitted, as control data specifying the action 1008, to the agent 1004), or the action selection unit 1026 may merely translate the policy output into a control input (i.e. control data in a format the agent can recognize and implement) to cause the agent 1004 to perform the identified action 1008.

In another example, the policy output may include a respective numerical value for each action in a set of actions. For example, the policy output may include a respective Q-value for each action in the fixed set. This may be generated by successively providing inputs to the policy neural network 1022 which are each the observation 1010 and one of the actions in the set, and forming the policy output as the corresponding successive outputs (Q-values) of the policy neural network 1022. A Q-value for an action is an estimate of a return that would result from the agent performing the action in response to the current observation and thereafter selecting future actions performed by the agent in accordance with current values of the parameters of the policy model neural network 1022 and the action selection unit 126.

The action selection unit 1026 may select the action 1008, e.g., by selecting the action with the highest numerical value, or by treating the numerical values in the policy output as a defining a probability distribution over the set of actions, and sampling an action in accordance with the probability distribution. For example, if the numerical values are Q-values, the action selection unit 1026 may process the Q-values (e.g., using a soft-max function) to generate a respective probability value for each action, which may be used to select the action, or may select the action with the highest Q-value.

As another example, when the action space is continuous, the policy output may include parameters of a probability distribution over the continuous action space and the action selection unit 1026 can select the action by sampling from the probability distribution or by selecting the mean action. A continuous action space is one that contains an uncountable number of actions, i.e., where each action is represented as a vector having one or more dimensions and, for each dimension, the action vector can take any value that is within the range for the dimension and the only constraint is the precision of the numerical format used by the system 1000.

As yet another example, when the action space is continuous the policy output may include a regressed action, i.e., a regressed vector representing an action from the continuous space, and the action selection unit 1026 may select the regressed action as the action 1008.

An observation of the environment at a certain time t during a certain episode is denoted by sₜ. For simplicity, it will be assumed in the following that the observation completely describes (“characterizes”) the state of the environment at that time, so that in some cases sₜ is described as the state of the environment at that time, but more generally the observation sₜ may not fully describe the state (e.g. it may only show part of the environment, or only show a view of the environment from one perspective).

The action 1008 performed by the agent 1004 at time t is denoted aₜ. At each time step t (except an initial time step, which may be denoted t=0), the state of the environment 106 at the time step, as characterized by the observation 1010 at the time step (i.e. sₜ), depends on the state of the environment 1006 at the previous time step t−1 and the action 108 performed by the agent 104 at the previous time step (i.e. aₜ₋₁).

As noted, the policy model neural network 1022 is defined by a set of numerical parameters ψ. A training system 1090 within the system 1000, or another training system, can train the policy model neural network 1022 (i.e. iteratively vary the numerical parameters of the policy model neural network 1022). This training may be performed in parallel with the selection of actions 1008 by the action selection subsystem 1002 (“online” training). Once the policy model neural network 1022 has been trained, the training system 1090 may be removed from the action selection system 1000, e.g. discarded.

Generally, the training is based on a reward value 1030 for each observation which is dependent on (i.e. derived using) the observation 1010, and which is generated using the observation 1010 by a reward calculation unit 1020. The reward value (or more simply “reward”) for a given time t, dependent on sₜ, is a scalar numerical value denoted rₜ, and characterizes the progress of the agent 1004 towards completing the task. The training process is called “reinforcement learning”.

The reward value 1030 is the value of a reward function of sₜ (and optionally of other data). Conventionally, a loss function is defined based on the reward values 1030 (e.g. a batch of data selected from the history database 1040), and the training of the policy model neural network 1022 is performed by the training system 1090 minimizing this loss function with respect to the parameters ψ. This may be done in examples of the present disclosure using the ES algorithms disclosed herein, e.g. methods 100 or 200 or the DES algorithm.

Note that in a variation, the training of the policy model neural network 1022 may be conducted in an “offline” algorithm. In this case, the policy model neural network 1022 is not used during the training to control an agent 1004. Instead, the training is based solely on the trajectories already stored in the history database 1040. The training is to modify the action selection subsystem to generate actions which are statistically associated with higher rewards, according to the data in the history database 1040. Algorithms are known for doing this, again based on minimizing a loss function with respect to the parameters ψ. Again, may be done in examples of the present disclosure using the ES algorithms disclosed herein.

Example environments and reinforcement learning tasks will now be described.

In some implementations, the environment is a real-world environment, the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate or manipulate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the positions, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements e.g. steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation e.g. steering, and movement e.g., braking and/or acceleration of the vehicle.

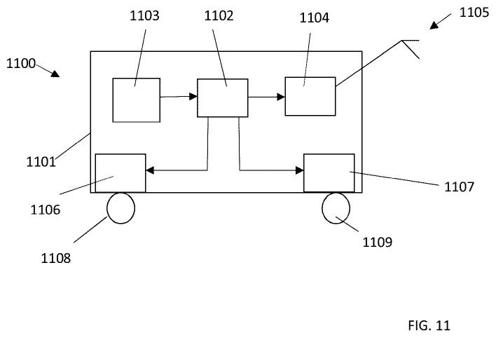

As an example, FIG. 11 shows a robot 1100 having a housing 1101. The robot includes, e.g. within the housing 1101 (or, in a variation, outside the robot 1100 but connected to it over a communications network), a control system 1102 which comprises an action selection system defined by a plurality of model parameters for each of one or more tasks which the robot is configured to perform. The control system 1102 may comprise the action selection subsystem 1002 of FIG. 10. The control system 1102 has access for a corresponding database of model parameters for each given task, which may have been obtained for that task by any of the ES methods disclosed herein. The robot 1100 further includes one or more sensors 1103 which may comprise one or more (still or video) cameras. The sensors 1103 capture observations (e.g. images) of an environment of the robot 1100, such as room in which the robot 1100 is located (e.g. a room of an apartment). The robot may also comprise a user interface (not shown) such as microphone for receiving user commands to define a task which the robot is to perform. Based on the task, the control system 1102 may read the corresponding model parameters and configure the action selection subsystem 1002 based on those model parameters. Note that, in a variation, the input from the user interface may be considered as part of the observations. There is only a single task in this case, and processing the user input is one aspect of that task.

Based on the observations captured by the sensors 1103, control system 1102 generates control data for an actuator 1104 which controls at least one manipulation tool 1105 of the robot, and control data for controlling drive system(s) 1106, 1107 which e.g. turn wheels 1108, 1109 of the robot, causing the robot 1100 to move through the environment according to the control data. Thus, the control system 1102 can control the manipulation tool(s) 1105 and the movement of the robot 1100 within the environment.

In some implementations the environment is a simulation of the above-described real-world environment, and the agent is implemented as one or more computers interacting with the simulated environment. For example the simulated environment may be a simulation of a robot or vehicle and the reinforcement learning system may be trained on the simulation and then, once trained, used in the real-world.

In some implementations the environment is a real-world manufacturing environment for manufacturing a product, such as a chemical, biological, or mechanical product, or a food product. As used herein a “manufacturing” a product also includes refining a starting material to create a product, or treating a starting material e.g. to remove pollutants, to generate a cleaned or recycled product. The manufacturing plant may comprise a plurality of manufacturing units such as vessels for chemical or biological substances, or machines, e.g. robots, for processing solid or other materials. The manufacturing units are configured such that an intermediate version or component of the product is moveable between the manufacturing units during manufacture of the product, e.g. via pipes or mechanical conveyance. As used herein manufacture of a product also includes manufacture of a food product by a kitchen robot.

The agent may comprise an electronic agent configured to control a manufacturing unit, or a machine such as a robot, that operates to manufacture the product. That is, the agent may comprise a control system configured to control the manufacture of the chemical, biological, or mechanical product. For example the control system may be configured to control one or more of the manufacturing units or machines or to control movement of an intermediate version or component of the product between the manufacturing units or machines.

As one example, a task performed by the agent may comprise a task to manufacture the product or an intermediate version or component thereof. As another example, a task performed by the agent may comprise a task to control, e.g. minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment e.g. between the manufacturing units or machines. In general the actions may be any actions that have an effect on the observed state of the environment, e.g. actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

The rewards or return may relate to a metric of performance of the task. For example in the case of a task that is to manufacture a product the metric may comprise a metric of a quantity of the product that is manufactured, a quality of the product, a speed of production of the product, or to a physical cost of performing the manufacturing task, e.g. a metric of a quantity of energy, materials, or other resources, used to perform the task. In the case of a task that is to control use a resource the matric may comprise any metric of usage of the resource.

In general observations of a state of the environment may comprise any electronic signals representing the functioning of electronic and/or mechanical items of equipment. For example a representation of the state of the environment may be derived from observations made by sensors sensing a state of the manufacturing environment, e.g. sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions e.g. a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g. data characterizing the current state of the machine or robot or of an item held or processed by the machine or robot. The observations may also include, for example, sensed electronic signals such as motor current or a temperature signal, or image or video data for example from a camera or a LIDAR sensor. Sensors such as these may be part of or located separately from the agent in the environment.

In some implementations the environment is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control e.g. cooling equipment, or air flow control or air conditioning equipment. The task may comprise a task to control, e.g. minimize, use of a resource, such as a task to control electrical power consumption, or water consumption. The agent may comprise an electronic agent configured to control operation of the items of equipment, or to control operation of the ancillary, e.g. environmental, control equipment.

In general the actions may be any actions that have an effect on the observed state of the environment, e.g. actions configured to adjust any of the sensed parameters described below. These may include actions to control, or to impose operating conditions on, the items of equipment or the ancillary control equipment, e.g. actions that result in changes to settings to adjust, control, or switch on or off the operation of an item of equipment or an item of ancillary control equipment.

In general observations of a state of the environment may comprise any electronic signals representing the functioning of the facility or of equipment in the facility. For example a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The rewards or return may relate to a metric of performance of the task. For example in the case of a task to control, e.g. minimize, use of a resource, such as a task to control use of electrical power or water, the metric may comprise any metric of use of the resource.

In some implementations the environment is the real-world environment of a power generation facility e.g. a renewable power generation facility such as a solar farm or wind farm. The task may comprise a control task to control power generated by the facility, e.g. to control the delivery of electrical power to a power distribution grid, e.g. to meet demand or to reduce the risk of a mismatch between elements of the grid, or to maximize power generated by the facility. The agent may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements e.g. to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g. an efficiency of the conversion or a degree of coupling of the energy input to the electrical energy output. Electrical control actions may, for example, comprise actions that control one or more of a voltage, current, frequency or phase of electrical power generated.

The rewards or return may relate to a metric of performance of the task. For example in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

In general observations of a state of the environment may comprise any electronic signals representing the electrical or mechanical functioning of power generation equipment in the power generation facility. For example a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such observations may thus include observations of wind levels or solar irradiance, or of local time, date, or season. Such sensors may include sensors configured to sense electrical conditions of the equipment such as current, voltage, power or energy; temperature or cooling of the physical environment; fluid flow; or a physical configuration of the equipment; and observations of an electrical condition of the grid e.g. from local or remote sensors. Observations of a state of the environment may also comprise one or more predictions regarding future conditions of operation of the power generation equipment such as predictions of future wind levels or solar irradiance or predictions of a future electrical condition of the grid.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that performs or controls the protein folding actions or chemical synthesis steps selected by the system automatically without human interaction. The observations may comprise direct or indirect observations of a state of the protein or chemical/intermediates/precursors and/or may be derived from simulation.

In a similar way the environment may be a drug design environment such that each state is a respective state of a potential pharmaceutically active compound and the agent is a computer system for determining elements of the pharmaceutically active compound and/or a synthetic pathway for the pharmaceutically active compound. The drug/synthesis may be designed based on a reward derived from a target for the pharmaceutically active compound, for example in simulation. As another example, the agent may be a mechanical agent that performs or controls synthesis of the pharmaceutically active compound.

In some applications the agent may be a software agent i.e. a computer program, configured to perform a task. For example the environment may be a circuit or an integrated circuit design or routing environment and the agent may be configured to perform a design or routing task for routing interconnection lines of a circuit or of an integrated circuit e.g. an ASIC. The reward(s) may then be dependent on one or more routing metrics such as interconnect length, resistance, capacitance, impedance, loss, speed or propagation delay; and/or physical line parameters such as width, thickness or geometry, and design rules. The reward(s) may also or instead include one or more reward(s) relating to a global property of the routed circuitry e.g. component density, operating speed, power consumption, material usage, a cooling requirement, level of electromagnetic emissions, and so forth. The observations may be e.g. observations of component positions and interconnections; the actions may comprise component placing actions e.g. to define a component position or orientation and/or interconnect routing actions e.g. interconnect selection and/or placement actions. The method may include making the circuit or integrated circuit to the design, or with interconnection lines routed as determined by the method.

In some applications the agent is a software agent and the environment is a real-world computing environment. In one example the agent manages distribution of tasks across computing resources e.g. on a mobile device and/or in a data center. In these applications, the observations may include observations of computing resources such as compute and/or memory capacity, or Internet-accessible resources; and the actions may include assigning tasks to particular computing resources. The reward(s) may be configured to maximize or minimize one or more of: utilization of computing resources, electrical power, bandwidth, and computation speed.

In another example the software agent manages the processing, e.g. by one or more real-world servers, of a queue of continuously arriving jobs. The observations may comprise observations of the times of departures of successive jobs, or the time intervals between the departures of successive jobs, or the time a server takes to process each job, e.g. the start and end of a range of times, or the arrival times, or time intervals between the arrivals, of successive jobs, or data characterizing the type of job(s). The actions may comprise actions that allocate particular jobs to particular computing resources; the reward(s) may be configured to minimize an overall queueing or processing time or the queueing or processing time for one or more individual jobs, or in general to optimize any metric based on the observations.

As another example the environment may comprise a real-world computer system or network, the observations may comprise any observations characterizing operation of the computer system or network, the actions performed by the software agent may comprise actions to control the operation e.g. to limit or correct abnormal or undesired operation e.g. because of the presence of a virus or other security breach, and the reward(s) may comprise any metric(s) that characterizing desired operation of the computer system or network.

In some applications, the environment is a real-world computing environment and the software agent manages distribution of tasks/jobs across computing resources e.g. on a mobile device and/or in a data center. In these implementations, the observations may comprise observations that relate to the operation of the computing resources in processing the tasks/jobs, the actions may include assigning tasks/jobs to particular computing resources, and the reward(s) may relate to one or more metrics of processing the tasks/jobs using the computing resources, e.g. metrics of usage of computational resources, bandwidth, or electrical power, or metrics of processing time, or numerical accuracy, or one or more metrics that relate to a desired load balancing between the computing resources.

In some applications the environment is a data packet communications network environment, and the agent is part of a router to route packets of data over the communications network. The actions may comprise data packet routing actions and the observations may comprise e.g. observations of a routing table which includes routing metrics such as a metric of routing path length, bandwidth, load, hop count, path cost, delay, maximum transmission unit (MTU), and reliability. The reward(s) may be defined in relation to one or more of the routing metrics i.e. configured to maximize one or more of the routing metrics.

In some other applications the environment is an Internet or mobile communications environment and the agent is a software agent which manages a personalized recommendation for a user. The observations may comprise previous actions taken by the user, e.g. features characterizing these; the actions may include actions recommending items such as content items to a user. The reward(s) may be configured to maximize one or more of: an estimated likelihood that the user will respond favorably to being recommended the (content) item, a suitability unsuitability of one or more recommended items, a cost of the recommended item(s), and a number of recommendations received by the user, optionally within a time span.

As a further example, the actions may include presenting advertisements, the observations may include advertisement impressions or a click-through count or rate, and the reward may characterize previous selections of items or content taken by one or more users.

In some cases, the observations may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

As another example the environment may be an electrical, mechanical or electro-mechanical design environment, e.g. an environment in which the design of an electrical, mechanical or electro-mechanical entity is simulated. The simulated environment may be a simulation of a real-world environment in which the entity is intended to work. The task may be to design the entity. The observations may comprise observations that characterize the entity, i.e. observations of a mechanical shape or of an electrical, mechanical, or electro-mechanical configuration of the entity, or observations of parameters or properties of the entity. The actions may comprise actions that modify the entity e.g. that modify one or more of the observations. The rewards or return may comprise one or more metric of performance of the design of the entity. For example rewards or return may relate to one or more physical characteristics of the entity such as weight or strength or to one or more electrical characteristics of the entity such as a measure of efficiency at performing a particular function for which the entity is designed. The design process may include outputting the design for manufacture, e.g. in the form of computer executable instructions for manufacturing the entity. The process may include making the entity according to the design. Thus the design of an entity may be optimized, e.g. by reinforcement learning, and then the optimized design output for manufacturing the entity, e.g. as computer executable instructions; an entity with the optimized design may then be manufactured.

As previously described the environment may be a simulated environment. Generally in the case of a simulated environment the observations may include simulated versions of one or more of the previously described observations or types of observations and the actions may include simulated versions of one or more of the previously described actions or types of actions. For example the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. Generally the agent may be implemented as one or more computers interacting with the simulated environment.

The simulated environment may be a simulation of a particular real-world environment and agent. For example, the system may be used to select actions in the simulated environment during training or evaluation of the system and, after training, or evaluation, or both, are complete, may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

Optionally, in any of the above implementations, the observation at any given time step may include data from a previous time step that may be beneficial in characterizing the environment, e.g., the action performed at the previous time step, the reward received at the previous time step, or both.

The subject matter described in this specification can be implemented in particular embodiments so as to realize one or more of the following advantages.

The method provides for an improved ES optimizer by parameterizing the search distribution update rule using an optimizer neural network. Rather than relying upon hand-crafted update rules, the update rule may be learned and adapted. In addition, the use of an attention block in the optimizer neural network provides for invariance to the ordering of candidate solutions in the update to the search distribution.

Further provided is a meta-learning procedure for obtaining the optimizer neural network. The meta-learning procedure enables an optimizer neural network to be obtained on the basis of learning on low dimensional optimization tasks and yet obtains an optimizer neural network for use in an ES optimizer that is capable of generalizing to optimization tasks of higher dimensionality and different domains.

The optimization tasks in the meta-learning procedure can be executed independently and therefore can be implemented in parallel on a distributed system. Further parallelism can be achieved by evaluating candidate solutions in parallel. The meta-learning procedure is scalable to larger population sizes and dimensionality and can also make more effective use of limited computational resources.

The update rules for the meta-learning procedure can also be parameterized by a meta-optimization neural network and be learned as the meta-learning procedure progresses allowing for self-evolution.

For a system of one or more computers to be configured to perform particular operations or actions means that the system has installed on IT software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them. The computer storage medium is not, however, a propagated signal.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows can be performed by and apparatus can also be implemented as a graphics processing unit (GPU).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

1. A computer-implemented method for updating a search distribution of an evolutionary strategies optimizer using an optimizer neural network comprising one or more attention blocks, the method comprising:
receiving a plurality of candidate solutions, one or more parameters defining the search distribution that the plurality of candidate solutions are sampled from, and fitness score data indicating a fitness of each respective candidate solution of the plurality of candidate solutions;
processing, by the one or more attention neural network blocks, the fitness score data using an attention mechanism to generate respective recombination weights corresponding to each respective candidate solution; and
updating the one or more parameters defining the search distribution based upon the recombination weights applied to the plurality of candidate solutions.

2. The method of claim 1, wherein processing, by the one or more attention neural network blocks, the fitness score data using an attention mechanism to generate respective recombination weights corresponding to each respective candidate solution comprises:
processing, by a query embedding neural network, the fitness score data to generate a query embedding for each respective candidate solution;
processing, by a key embedding neural network, the fitness score data to generate a key embedding for each respective candidate solution;
processing, by a value embedding neural network, the fitness score data to generate a value embedding for each respective candidate solution;
generating attention weights based upon a dot product attention mechanism between the query embedding and key embedding for each respective candidate solution; and
generating the recombination weights corresponding to each respective candidate solution based upon applying the attention weights to the value embedding for each respective candidate solution.

3. The method of claims 1, wherein the fitness score data comprises one or more of the following: a fitness score for a respective candidate solution, a ranking of the respective candidate solution, and an indication of whether the fitness score of the respective candidate solution exceeds a previous best fitness score.

4. The method of claim 1, wherein updating the one or more parameters defining the search distribution based upon the recombination weights applied to the plurality of candidate solutions comprises:
aggregating the values of the recombination weights applied to the plurality of candidate solutions and applying at least one learning rate parameter to the aggregated values to generate an update value; and
updating the one or more parameters based upon the at least one update value.

5. The method of claim 4, wherein the optimizer neural network further comprises a learning rate update unit configured to process an input based upon the recombination weights and a current value of the at least one learning rate parameter, to generate an updated value for the at least one learning rate parameter.

6. The method of claim 5, wherein the learning rate update unit is further configured to process a timestamp embedding to generate the updated value for the at least one learning rate parameter.

7. The method of claim 1, wherein the search distribution is a diagonal Gaussian distribution and the one or more parameters comprises a mean vector and a standard deviation vector.

8. The method of claim 1, further comprising: generating a solution using the updated search distribution and outputting the generated solution.

9. The method of claim 1, wherein the evolutionary strategies optimizer is configured to output a neural network for performing a task and each respective candidate solution represents a candidate neural network for performing the task.

10. The method of claim 9, in which the task is one of the group consisting of:
from one or more images, or features extracted from one or more images, obtaining for each of a set of multiple categories, an estimated likelihood that the one or more images contain an image of an object which is in the category;
an image segmentation task;
an image keypoint detection task;
recognition of what action is being performed in a video segment;
processing a text input to the neural network in one language to generate an estimate that a piece of text in another language is a proper translation of the input text into the other language;
processing a sequence representing a spoken utterance, to generate a score for each of a set of pieces of text, each score representing an estimated likelihood that the piece of text is the correct transcript for the utterance; or
a task of controlling an agent to perform a manipulation and/or navigation within a real-world environment based on observations of the environment made using one or more sensors.

11. A system comprising:
one or more computers; and
one or more storage devices communicatively coupled to the one or more computers, wherein the one or more storage devices store instructions that, when executed by the one or more computers, cause the one or more computers to perform operations for updating a search distribution of an evolutionary strategies optimizer using an optimizer neural network comprising one or more attention blocks, the operations comprising:
receiving a plurality of candidate solutions, one or more parameters defining the search distribution that the plurality of candidate solutions are sampled from, and fitness score data indicating a fitness of each respective candidate solution of the plurality of candidate solutions;
processing, by the one or more attention neural network blocks, the fitness score data using an attention mechanism to generate respective recombination weights corresponding to each respective candidate solution; and
updating the one or more parameters defining the search distribution based upon the recombination weights applied to the plurality of candidate solutions.

12. The system of claim 11, wherein processing, by the one or more attention neural network blocks, the fitness score data using an attention mechanism to generate respective recombination weights corresponding to each respective candidate solution comprises:
processing, by a query embedding neural network, the fitness score data to generate a query embedding for each respective candidate solution;
processing, by a key embedding neural network, the fitness score data to generate a key embedding for each respective candidate solution;
processing, by a value embedding neural network, the fitness score data to generate a value embedding for each respective candidate solution;
generating attention weights based upon a dot product attention mechanism between the query embedding and key embedding for each respective candidate solution; and
generating the recombination weights corresponding to each respective candidate solution based upon applying the attention weights to the value embedding for each respective candidate solution.

13. The system of claim 11, wherein the fitness score data comprises one or more of the following: a fitness score for a respective candidate solution, a ranking of the respective candidate solution, and an indication of whether the fitness score of the respective candidate solution exceeds a previous best fitness score.

14. The system of claim 11, wherein updating the one or more parameters defining the search distribution based upon the recombination weights applied to the plurality of candidate solutions comprises:
aggregating the values of the recombination weights applied to the plurality of candidate solutions and applying at least one learning rate parameter to the aggregated values to generate an update value; and
updating the one or more parameters based upon the at least one update value.

15. The system of claim 14, wherein the optimizer neural network further comprises a learning rate update unit configured to process an input based upon the recombination weights and a current value of the at least one learning rate parameter, to generate an updated value for the at least one learning rate parameter.

16. One or more non-transitory computer storage media storing instructions that when executed by one or more computers cause the one or more computers to perform operations for updating a search distribution of an evolutionary strategies optimizer using an optimizer neural network comprising one or more attention blocks, the operations comprising:
receiving a plurality of candidate solutions, one or more parameters defining the search distribution that the plurality of candidate solutions are sampled from, and fitness score data indicating a fitness of each respective candidate solution of the plurality of candidate solutions;
processing, by the one or more attention neural network blocks, the fitness score data using an attention mechanism to generate respective recombination weights corresponding to each respective candidate solution; and
updating the one or more parameters defining the search distribution based upon the recombination weights applied to the plurality of candidate solutions.

17. The non-transitory computer storage media of claim 16, wherein processing, by the one or more attention neural network blocks, the fitness score data using an attention mechanism to generate respective recombination weights corresponding to each respective candidate solution comprises:
processing, by a query embedding neural network, the fitness score data to generate a query embedding for each respective candidate solution;
processing, by a key embedding neural network, the fitness score data to generate a key embedding for each respective candidate solution;
processing, by a value embedding neural network, the fitness score data to generate a value embedding for each respective candidate solution;
generating attention weights based upon a dot product attention mechanism between the query embedding and key embedding for each respective candidate solution; and
generating the recombination weights corresponding to each respective candidate solution based upon applying the attention weights to the value embedding for each respective candidate solution.

18. The non-transitory computer storage media of claim 16, wherein the fitness score data comprises one or more of the following: a fitness score for a respective candidate solution, a ranking of the respective candidate solution, and an indication of whether the fitness score of the respective candidate solution exceeds a previous best fitness score.

19. The non-transitory computer storage media of claim 16, wherein updating the one or more parameters defining the search distribution based upon the recombination weights applied to the plurality of candidate solutions comprises:
aggregating the values of the recombination weights applied to the plurality of candidate solutions and applying at least one learning rate parameter to the aggregated values to generate an update value; and
updating the one or more parameters based upon the at least one update value.

20. The non-transitory computer storage media of claim 19, wherein the optimizer neural network further comprises a learning rate update unit configured to process an input based upon the recombination weights and a current value of the at least one learning rate parameter, to generate an updated value for the at least one learning rate parameter.
